(19) United States
(12) Patent Application Publication
(10) Pub. No.: US 2017/0286975 A1
(43) Pub. Date: Oct. 5, 2017

(54) Data Infrastructure and Method for Estimating Influence Spread in Social Networks

(71) Applicant: Sysomos L.P., Toronto (CA)

(72) Inventors: Koushik PAL, Etobicoke (CA); Zisis Paraskevas POULOS, Toronto (CA)

(73) Assignee: Sysomos L.P., Toronto (CA)

(21) Appl. No.: 15/447,765

(22) Filed: Mar. 2, 2017

Related U.S. Application Data
(60) Provisional application No. 62/316,902, filed on Apr. 1, 2016.

(51) Int. Cl. G06Q 30/02; G06N 3/00; G06F 17/18; H04L 29/08; G06F 17/30

(52) U.S. Cl. CPC G06Q 30/0201; H04L 67/10; G06F 17/30958; G06F 17/3048; G06F 17/18; G06N 3/004; G06Q 50/01

(57) ABSTRACT

A system and method are provided for determining influence spread in social networks. The method includes generating a plurality of samples using a computing device, each sample corresponding to a collection of all edge weights for a social network graph topology; and allocating, by the computing device, the plurality of samples into at least one batch, a size of which is being determined according to a number of threads and global memory space available in a multi-processor platform. For each batch, the method includes parallel processing the samples in that batch using the multi-processor platform to generate results corresponding to a spread of each graph node per sample in that batch; storing results of that batch in the global memory accessible to the multi-processor platform; and sending the results to the computing device. The method also includes computing, using the computing device, an average spread of each node across all samples in all batches; and determining, from the average spreads, one or more nodes having a largest spread.

### CROSS-REFERENCE TO RELATED APPLICATIONS:

This application claims priority to U.S. Provisional Patent Application No. 62/316,902 filed on Apr. 1, 2016, entitled “Data Infrastructure and Method for Estimating Influence Spread in Social Networks” and the entire contents of which is incorporated herein by reference.

### TECHNICAL FIELD

The following relates to systems and methods for estimating influence spread in social networks.

### DESCRIPTION OF THE RELATED ART

In recent years social media has become a popular way for individuals and consumers to interact online (e.g. on the Internet). Social media also affects the way businesses aim to interact with their customers, fans, and potential customers online.

Some users on particular topics with a wide following are identified and are used to endorse or sponsor specific products. For example, advertisement space on a popular blogger's website is used to advertise related products and services.

Social network platforms are known to be used to communicate with a targeted group of people, or advertise to a targeted group of people. Examples of social network platforms include (but are not limited to) those known by the trade names Facebook, Twitter, LinkedIn, Tumblr, Instagram, and Pinterest.

Such social network platforms are also used to influence groups of people, since online social networks enable large scale word-of-mouth marketing. For instance, massive social networks, such as Facebook, Twitter, and Instagram, include billions of users (e.g. data nodes) and trillions of edges (e.g. data links) representing interactions, dictating opinions, and causing viral explosions. Quickly identifying relevant target groups and/or popular or influential individuals, and accurately identifying influential individuals that should be targeted initially, such that an expected number of follow-ups is maximized for a particular topic, can be difficult and computationally expensive, particularly as number of users within a social network grows.

### SUMMARY

Below are example embodiments and example aspects of the data infrastructure system and methods for estimating influence spread in a social network. These example embodiments and aspects are non-limiting. Alternative embodiments or additional details, or both, are provided in the accompanying figures and the below detailed description.

In a general example embodiment, a method is provided for determining influence spread in social networks, the method comprising: generating a plurality of samples using a computing device, each sample corresponding to a collection of all edge weights for a social network graph topology; allocating, by the computing device, the plurality of samples into at least one batch, a size of which is being determined according to a number of threads and global memory space available in a multi-processor platform; for each batch: parallel processing the samples in that batch using the multi-processor platform to generate results corresponding to a spread of each graph node per sample in that batch; storing results of that batch in the global memory accessible to the multi-processor platform; and sending the results to the computing device; computing, using the computing device, an average spread of each node across all samples in all batches; and determining, from the average spreads, one or more nodes having a largest spread.

In other example embodiments, computing systems and computer readable media are provided that are configured to perform the above method.

### BRIEF DESCRIPTION OF THE DRAWINGS

Embodiments will now be described by way of example only with reference to the appended drawings wherein:

FIG. 1 is a schematic diagram of a data architecture and system for estimating influence spread in social networks;

FIG. 2 is a graphical representation of influence spread with a social network graph;

FIG. 3 is a graphical representation of influence spread over time;

FIG. 4 is a graphical representation of a continuous-time independent cascade model;

FIG. 5 illustrates an example shortest path between nodes 1 and 4, using the model shown in FIG. 4;

FIG. 6 is a graphical representation of influence maximization in the continuous-time domain with a time deadline;

FIG. 7 is a graphical representation of a naïve sampling application on a number of network graph samples;

FIG. 8 is a graphical representation of a Cohen's estimator sampling application on a number of network graph samples;

FIG. 9 is a graphical representation of a series of samples of edge weights pre-stored for parallel processing;

FIG. 10 is a schematic diagram of a batch sampling process using a multi-processing platform;

FIG. 11 is a graphical illustration of an edge weight order rearrangement to improve latency in a GPU implementation;

FIG. 12 is a flow chart illustrating operations performed in estimating influence spread in a social network;

FIG. 13 is a chart illustrating the effect of using texture memory for read-only data in a Twitter-based graph;

FIG. 14 is a chart illustrating the effect of using texture memory for read-only data in a Google medium-based graph;

FIG. 15 is a chart illustrating performance of a GPU versus a CPU for a Twitter-based graph;

FIG. 16 is a chart illustrating performance of a GPU versus a CPU for a Google medium-based graph; and

FIG. 17 is a schematic block diagram of an example of a configuration for a social network intelligence system and a computing device connectable to a communication network.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Influence spread can be efficiently estimated by utilizing a multi-processing platform such as a GPU, multi-core processor, etc. It is recognized that the processing of samples of edge weights in a network graph are independent of each other and lend themselves to processing in a parallelized manner, e.g., using a known sampling method such as Naïve Sampling or Cohen's Estimator algorithms, particularly using a multi-processing environment that includes many threads, e.g., a GPU-based environment.

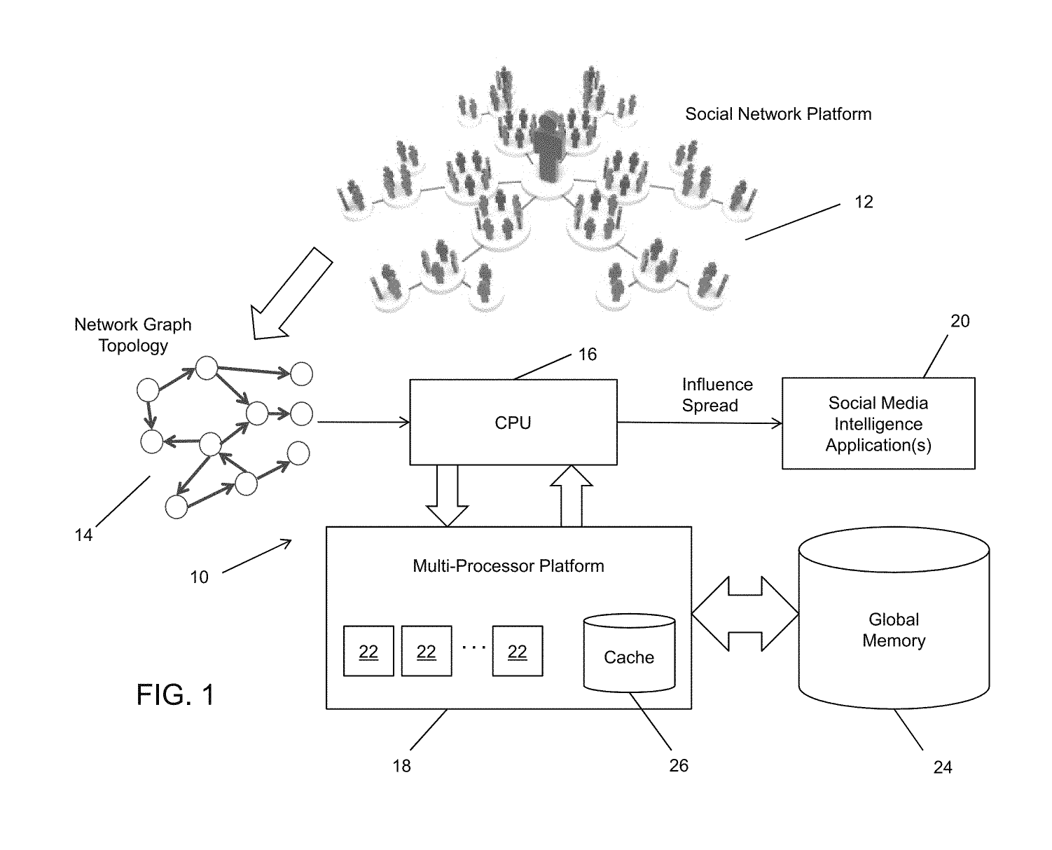

Turning now to the figures, FIG. 1 illustrates a data infrastructure and system 10 for estimating influence spread in a social network platform 12. The social network platform 12 is represented using a network graph 14, that typically includes a continuously evolving topology that is used to estimate the influence spread in that social network at that time. The system 10 includes a central processing unit (CPU) 16 and a multi-processor platform 18 such as a general purpose graphics processing unit (GPU hereinafter), multi-core processor, etc. to estimate the influence spread using edge and node information in the network graph. In an example embodiment, the CPU 16 may have one or multiple processing cores, and the CPU may also be called a central processing system. In this example illustration, the influence spread is estimated for or on behalf of one or more social media intelligence applications 20, however, it can be appreciated that the system 10 and application(s) 20 can also be integrated into a single system. The multi-processor platform 18 includes a number of processing entities 22 (e.g., threads, processors, etc.) and a memory cache 26. The multi-processor platform 18 is coupled or otherwise connected to a global memory 24 to store the results of data computations as described in greater detail below.

Social networking platforms 12 include users who generate and post content for others to see, hear, etc. (e.g. via a network of computing devices communicating through websites associated with the social networking platform). Non-limiting examples of social networking platforms 12 are Facebook, Twitter, LinkedIn, Pinterest, Tumblr, Instagram, blogospheres, websites, collaborative wikis, online newsgroups, online forums, emails, and instant messaging services. Currently known and future known social networking platforms 12 may be used with principles described herein. Social networking platforms 12 can be used to market to, and advertise to, users of the platforms 12. Although the principles described herein may apply to different social networking platforms 12, many of the examples are described with respect to Twitter to aid in the explanation of the principles.

More generally, social networks allow users to easily pass on information to all of their followers (e.g., re-tweet or @reply using Twitter) or friends (e.g., share using Facebook).

The terms “friend” and “follower” are defined below.

The term “follower”, as used herein, refers to a first user account (e.g. the first user account associated with one or more social networking platforms 12 accessed via a computing device) that follows a second user account (e.g. the second user account associated with at least one of the social networking platforms 12 of the first user account and accessed via a computing device), such that content posted by the second user account is published for the first user account to read, consume, etc. For example, when a first user follows a second user, the first user (i.e. the follower) will receive content posted by the second user. In some cases, a follower engages with the content posted by the other user (e.g., by sharing or reposting the content). The second user account is the “followee” and the follower follows the followee.

It will be appreciated that a user account is a known term in the art of computing. In some cases, although not necessarily, a user account is associated with an email address. A user has a user account and is identified to the computing system by a username (or user name). Other terms for username include login name, screen name (or screenname), nickname (or nick) and handle.

A “friend”, as used herein, is used interchangeably with a “followee”. In other words, a friend refers to a user account, for which another user account can follow. Put another way, a follower follows a friend.

A “social data network” or “social network”, as used herein includes one or more social data networks based on different social networking platforms 12. For example, a social network based on a first social networking platform 12 and a social network based on a second social networking platform 12 may be combined to generate a combined social data network. A target audience of users may be identified using the combined social data network, or also simply herein referred to as a “social data network” or “social network”.

Examples of social media intelligence applications 20 that can use or otherwise benefit from the results generated by the system 10 include, without limitation, Sysomos Influence (for determining top influencers and influencer communities), Sysomos MAP (for viral marketing), etc.

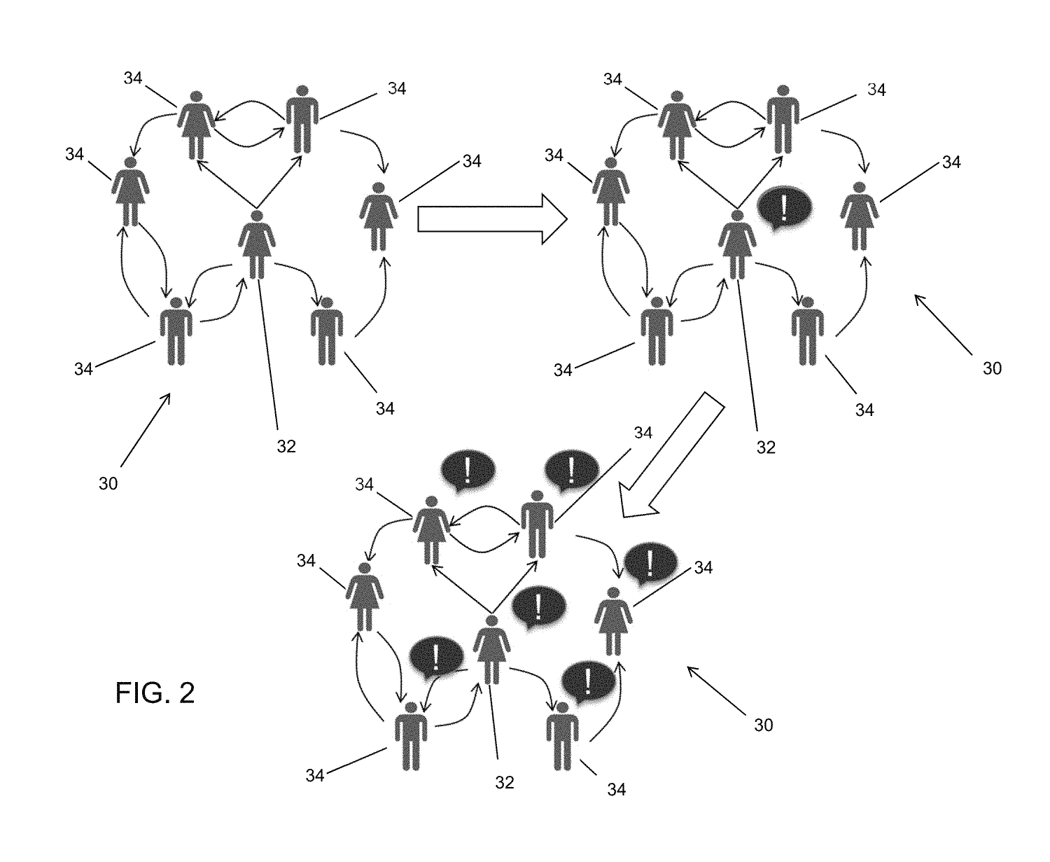

FIG. 2 illustrates an example of a portion 30 of a network graph 14. The graph portion 30 in this example includes a number of influencer nodes 32 and a number of nodes 34 potentially influenced by such influencer nodes 32. In a word-of-mouth marketing strategy, identifying the influencer nodes 32, namely the individuals that should be targeted initially, such that the expected number of follow-ups is maximized is an important determination. The influencer nodes 32 are those that, if they are convinced to adopt a particular idea or product (see second version of graph portion 30), are expected to endorse the idea or product among their friends or followers thus spreading their influence (see third version of graph portion 30). The input to the system 10 is a directed graph 14 that has a distribution associated with each edge. In the examples shown herein, this distribution is an exponential distribution with a parameter λ that varies from edge to edge.

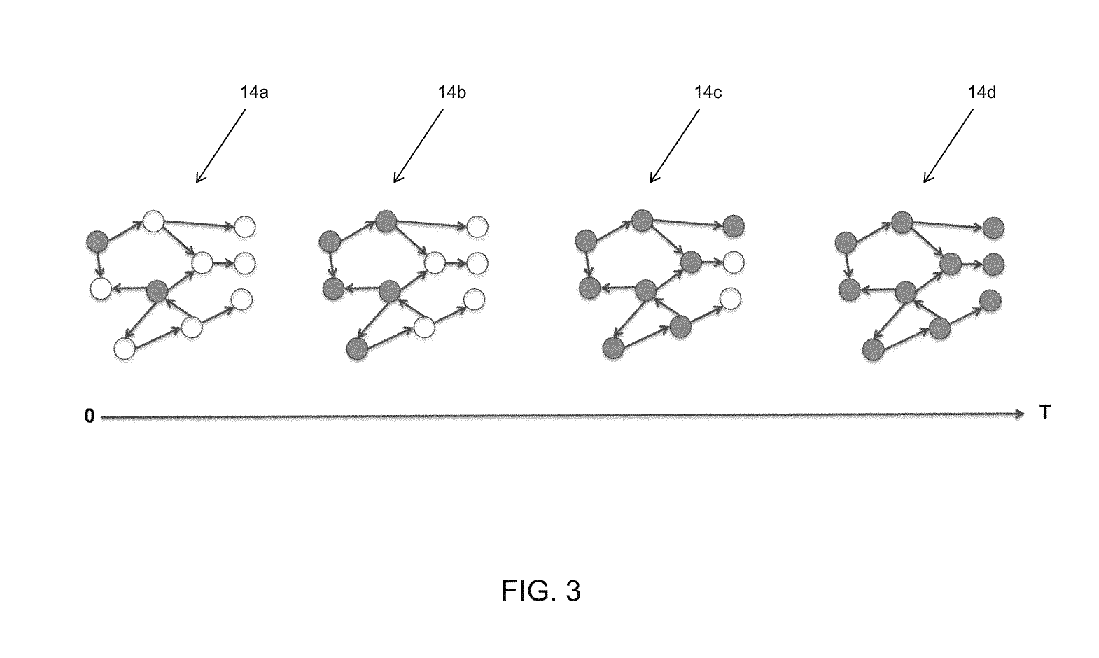

Traditionally, time has not been taken into account when determining the influence spread illustrated in FIG. 2. As shown in FIG. 3, the follow-ups or spread (depicted using darkened nodes in the progressive depictions of the graph 14a, 14b, 14c, and 14d) should be maximized, but also considering time, e.g., by identifying a deadline T. The deadline T can vary based on the application, and is typically associated with a time within which the influence of the influencer nodes 32 remains relevant (e.g. to a particular campaign).

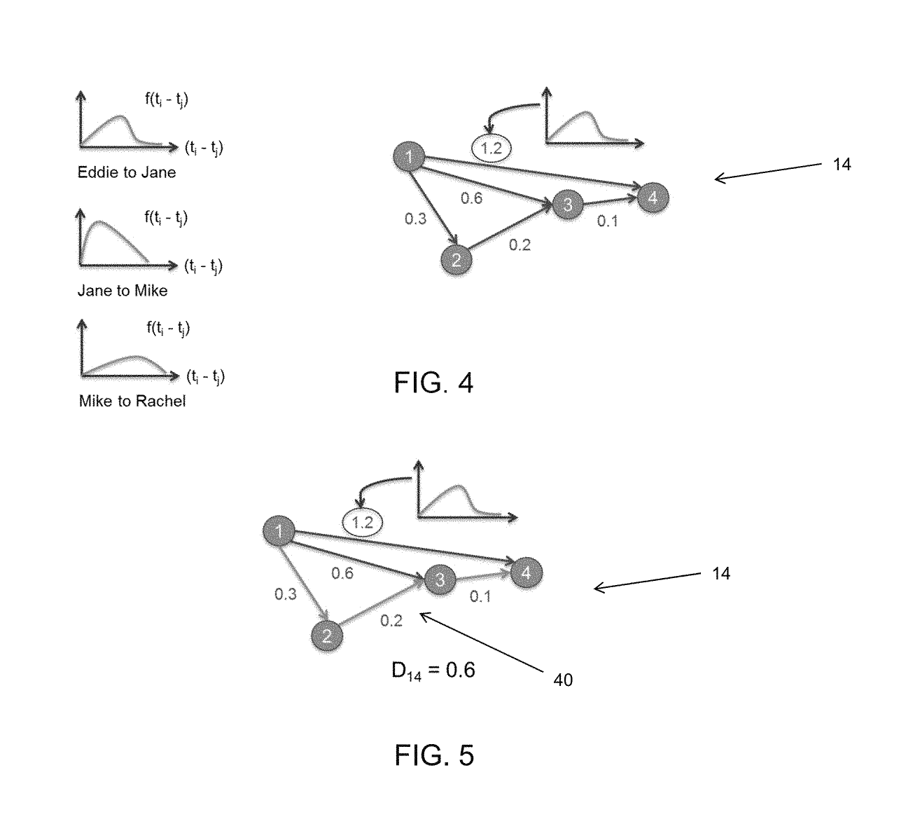

FIGS. 4, 5 and 6 illustrate influence maximization in the continuous-time domain, according to a continuous-time independent cascade model. In this illustration, “infection” refers to the notion of a node adopting the opinion, product, service, etc. of another node. This is modeled by considering the pairwise conditional density between nodes, over time denoted by the function fⱼᵢ(tⱼ|tᵢ), which denotes the conditional density that node j is infected at time tⱼ, given that node i is infected at time tᵢ.

One simplified assumption on such a density function is that the time taken by node i to infect node j does not depend on the actual time node i infects node j, i.e.:

fⱼᵢ(tⱼ|tᵢ)=fⱼᵢ(tᵢ−tⱼ).

Sampling is used to generate the edge weights. As shown in FIG. 5, according to a shortest path property, for a given sample, node 1 infects node 4 after time D₁₄, which is equal to the length of the shortest path between nodes 1 and 4. In the example shown in FIG. 5, D₁₄=0.6.

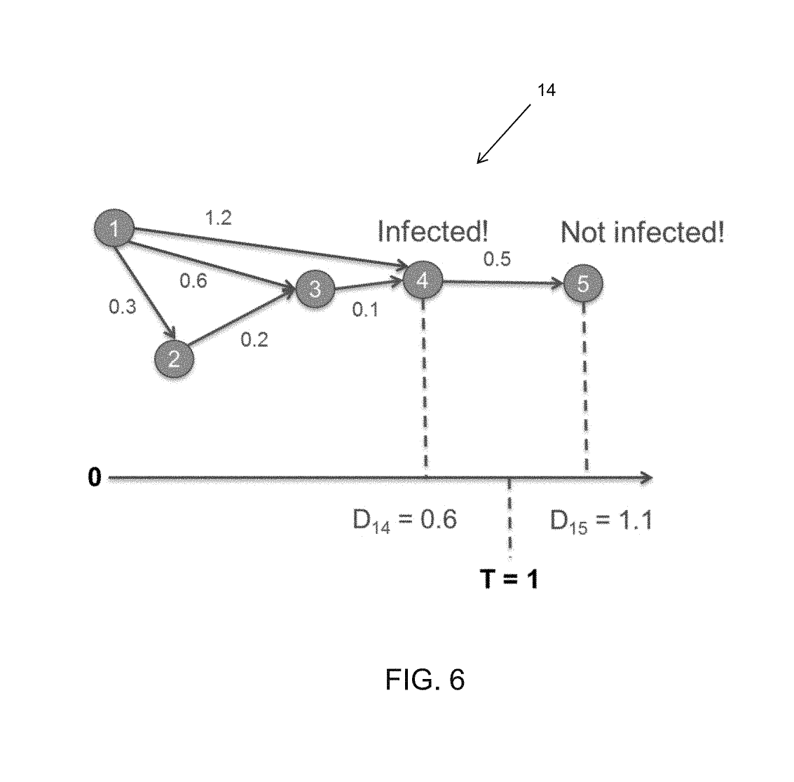

In reality it is appreciated that a campaign has either a strict or effective “deadline” of time T. FIG. 6 illustrates the role of T in the influence spread. In this case, where T=1, D₁₅=1.1 is considered to not be infected since the time it takes node 1 to infect node 5 is beyond the time deadline T. It may be noted that the infected nodes may change per sample (i.e. a particular node may be infected by one node from one sample, but not infected by the same node from a different sample). The expected spread of a node (or set of nodes) is equal to the average number of nodes that it infects across all samples, in this case within the deadline T.

For a given sample, the spread of node i is equal to the number of nodes infected by node i within time T. As such, the system 10 is interested in σ(i)=expected spread of node i=average # of nodes infected by i across all samples. This can be generalized for a set of nodes, A, namely σ(A). Given the directed graph G(V,E), with vertices V and edges E, the edge weight distributions, and a budget k, an objective is to find a set S of at most k nodes (i.e. a seed set) that maximizes σ(A), or S←argmax_{A:|A|≦k}σ(A).

Accordingly, the problem to be addressed in determining influence spread in the social network is to find a set S of k nodes (i.e. the seed set) that maximizes the expected spread σ(S). To do so, an approximation algorithm can be applied as follows (Kempe et al., 2003):

1. Initialize S = Ø
2. for i = 1 to k do
3. select u ← argmax_{W∈V\S}[σ(SU{w}) − σ(S)]

| | |
|---|---|
| 3.1 for j = 1 to N do | // N samples, ≈ 100,000 in this example |

| | | |
|---|---|---|
| 3.2 | for all nodes not in S do | // # nodes, \|V\| |

| | |
|---|---|
| 3.3 | enumerate shortest paths ≦ T |

3.4 return u ← node with max # of such paths
4. S ← S ∪ {u}
5. end for
6. return S

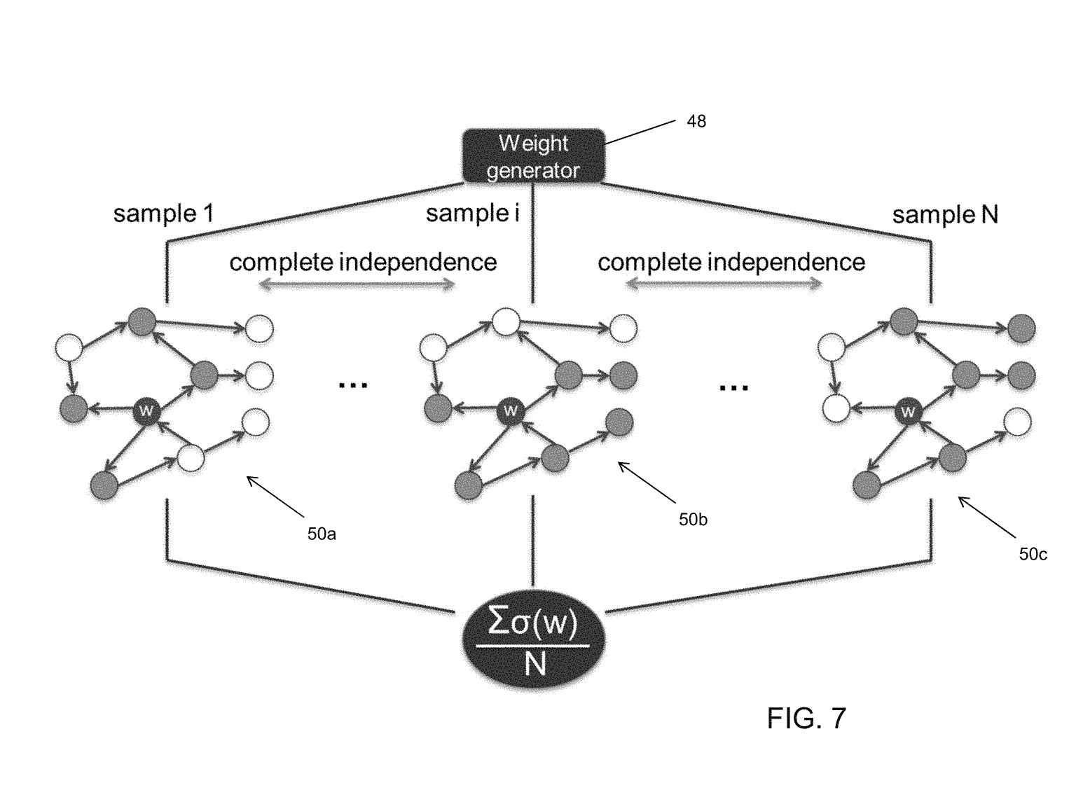

It has been observed that processing samples of a social network graph is at least in part inherently parallelizable since each sample that is processed, is processed independently and thus can be processed in parallel processes or threads. As such, multi-processing platforms 18 such as GPUs are particularly well suited to perform an influence spread calculation. As illustrated in FIG. 7, the algorithm above can therefore be applied to each one of N samples independently, using Naïve Sampling. In FIG. 7, three samples 50a, 50b, and 50c are shown for illustrative purposes. It can be appreciated that each sample 50 of a graph 14 includes generated weights for all of the edges of the graph 14 from their corresponding distributions. Each sample can also be considered a collection of number-of-many-edges random numbers, which are chosen from the corresponding distributions on the edges.

A weight generator 48 generates the weights for the edges, which are used in the parallel sample processing. The results of all samples are then averaged by summing the results and dividing that by the number of samples:

$$\frac{Σσ ( w )}{N} .$$

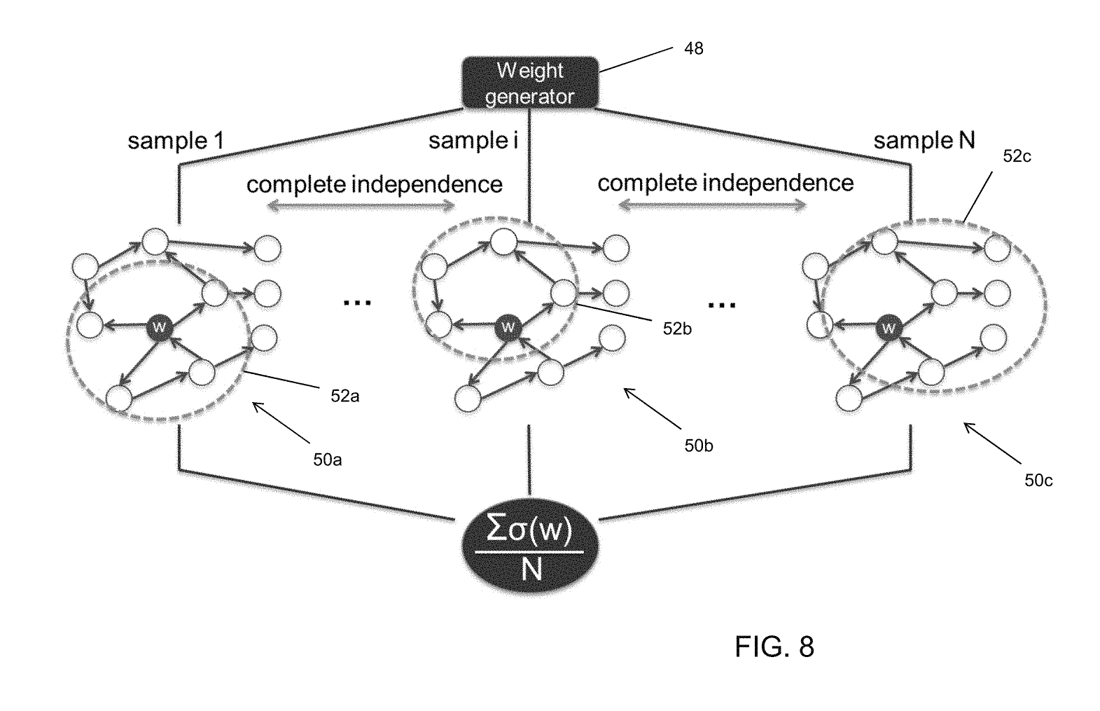

Instead of Naïve Sampling, the system can also be configured to have the multi-processor platform 18 utilize other algorithms, such as Cohen's Neighborhood Size Estimation Algorithm shown in FIG. 8. Cohen's Neighborhood Size Estimation Algorithm was proposed by Nan Du et al., 2003 (ConTinEst framework) and replaces an all-pairs shortest paths type approach with Cohen's randomized algorithm. This algorithm estimates the neighborhood size (spread) per node, per sample. In FIG. 8, three neighborhoods 52a, 52b, and 52c are shown for illustrative purposes. It has been found that Cohen's Neighborhood Size Estimation Algorithm can operate faster by a

$$O ( \frac{\vert V \vert}{log \vert V \vert} )$$

factor, and also requires fewer samples. The tradeoff when compared to, for example, Naïve Sampling, is speed versus accuracy. With Cohen's Neighborhood Estimation Algorithm, the subroutine 3.1-3.4 (see above) can be modified as follows:

| | |
|---|---|
| 3.1 for j = 1 to N do | // N samples, ≈ 10,000 in this example |

| | | |
|---|---|---|
| 3.2 | for all nodes not in S do | // # nodes, \|V\| |

| | |
|---|---|
| 3.3 | estimate d-neighborhood with d ≦ T |

3.4 return u ← node with largest neighborhood

It can be seen that there are an order of magnitude fewer samples, and by looking at neighborhoods instead of number of paths, further performance gains can be achieved.

Naïve Sampling can be considered “embarrassingly parallel” (i.e. where little or no effort is required to separate the problem into a number of parallel tasks) since it has virtually complete independence across samples that are being processed. Typically, the number of samples required is between 100,000 and 1,000,000 to achieve convergence, which motivates acceleration. Cohen's Neighborhood Size Estimation Algorithm requires an inner loop (e.g., with approx. 5-10 inner samples) and an outer loop (e.g., with approx. 10,000 to 50,000 outer samples), and the core randomized algorithm exhibits complete independence across both inner and outer samples. Since the number of samples is also less, it is recognized that it makes more sense to parallelize the outer loop.

There are also space versus speed trade-offs to consider. For example, there is a need to pre-generate the weights (on the host (CPU) versus the device (GPU)), a need to balance data loads/unloads between the host (CPU) and the device (GPU), and thus, as described in more detail below, batch sampling is utilized to process large numbers of samples.

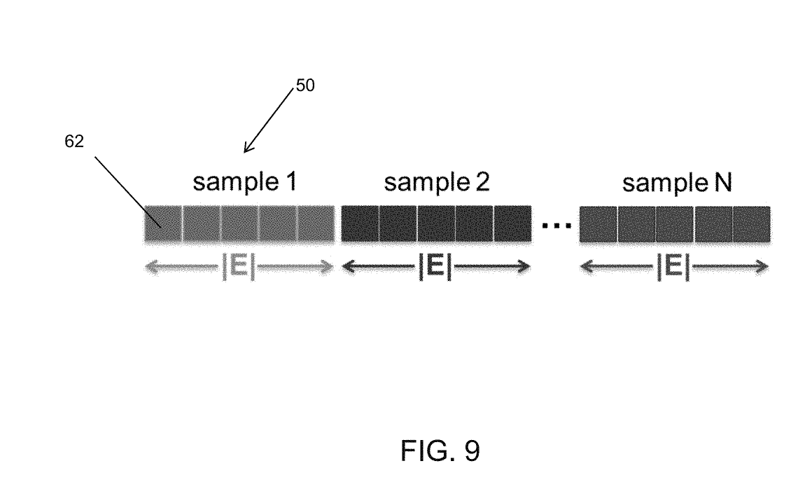

Referring to FIG. 9, for data allocation on the host (CPU) side, one implementation is as follows. For a directed graph G, namely G(V,E), which is an adjacency list representation O(|V|+|E|). The edge weights are pre-generated and stored for all samples O(N*|E|). It can be appreciated that an adjacency list representation is only one way to present a graph. For example, an adjacency matrix representation is also possible. Because of this, memory usage can be intensive, for example, 2 GB for a small 200-node network, and 1M samples.

By implementing batch sampling/allocation, these issues can be addressed. To do so, one can fix the batch size to a constant size B, such that B samples are passed to the multi-processor platform 18, which implies, in the context of a GPU, that N/B threads are available and utilized. As shown in FIG. 9, each sample 50 comprises a set |E| of edge weights 62 that are to be used in computing the spread for that sample 50.

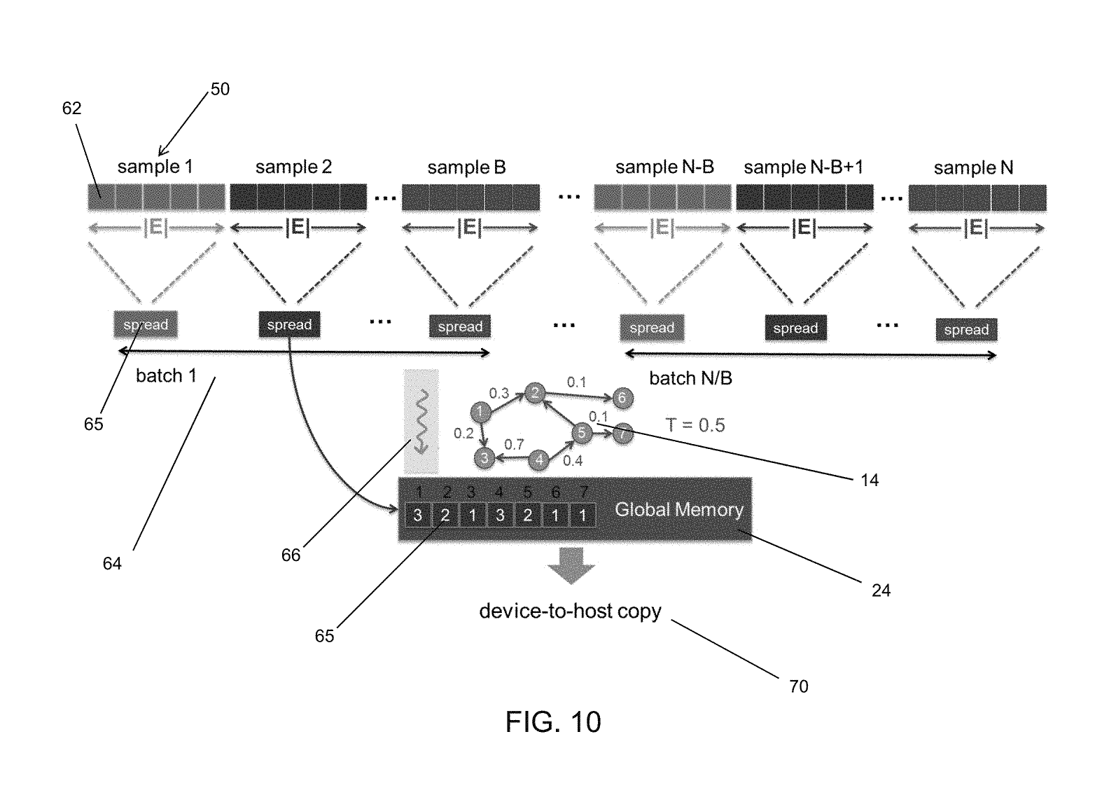

An example of a batch processing implementation using a multi-processor platform 18 such as a GPU, is illustrated pictorially in FIG. 10. As noted above, each sample 50 has a collection |E| of edge weights 62. With N samples and a batch size of B, the CPU 16 determines that the graph 14 should be processed using N/B batches. In Naïve Sampling, the CPU 16 passes each batch 64 to the multi-processor platform 18 (e.g. GPU) and the GPU in this example would compute the spread of all the nodes across all samples in that batch 64 and passes that information back to the CPU 16 as explained below.

Each batch 64 of B samples 50 is processed at each iteration of the processing algorithm to generate a spread 65. Each sample 50 is processed in a thread 66 (or stream) of the multi-processor platform 18 such as a GPU, with a given network topology 14 and a time T, in this example=0.5 to obtain the spread values 65. The results of the computations of each sample are stored in the global memory 24 of the multi-processor platform 18. FIG. 10 illustrates some example spread values 65 for 7 nodes for the example graph 14 and using T=0.5. All samples 50 in that batch 64 are processed in parallel and the computations for each batch 64, when completed, are sent from the multi-processor platform 18 to the CPU 16 as a device-to-host copy 70, and the next batch 64 is processed until all N/B batches are processed.

The CPU 16 collects all spreads computed by the multi-processor platform 18 and passed thereto and computes the average spread for all the nodes and across all samples. From this, the CPU 16 can find the seed with the maximum spread. This process can be repeated a plurality of times until the number of required seeds is found.

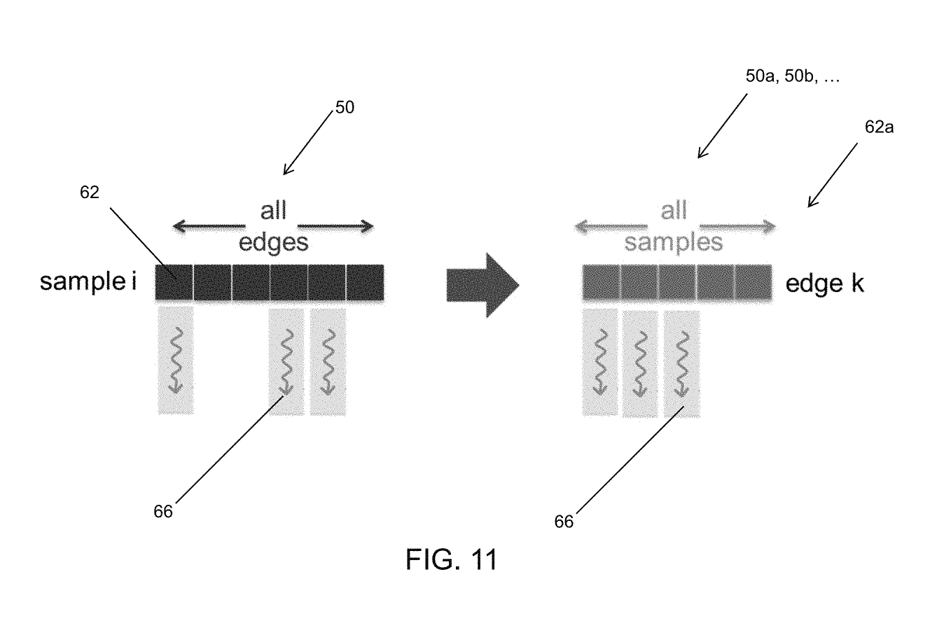

It has been recognized that the inherent randomness of the influence spread computations can cause poor memory coalescence, causing potential latency problems in a GPU. For example, adjacent threads 66 may need to access edge weights 62 far apart in memory. In one enhancement, as shown in FIG. 11, the edge weight order can be rearranged on the global memory 24. As illustrated in FIG. 11, the edges 62 can be numbered from 1 through |E|, where |E| is the number of edges 62. The weights for edge 1, from all samples 50a, 50b, 50c, etc., may then be stored together as one block. This is followed by all weights for edge 2 from all samples, etc. This rearrangement is shown in the right diagram in FIG. 11. This can be contrasted to the arrangement shown in the left diagram which stores one sample of the entire graph 14, followed by another sample of the entire graph, etc. Using the rearrangement on the right, the threads can make better use of the GPU cache at any given time, thereby improving latency.

In another enhancement, a 1D texture memory structure can be used for read-only data (weights, topology, etc.). By using texture memory, a block of the GPU global memory 24 is fetched at once, each time any thread tries to fetch something from the GPU global memory 24 (rather than only fetching that something). This can help nearby threads 66 if they are also trying to access nearby GPU global memory 24, thereby reducing the number of calls to the GPU memory 24, which can improve latency.

In yet another enhancement, the L1 cache can be disabled resulting in fewer wasteful fetches. The L1 cache is a small pool of memory attached to each streaming processor in a GPU. The L1 cache stores data that are likely to be used often by the processor. In this way, each time a new request for data occurs, then those can be found in the L1 cache instead of looking up in the global memory 24, which can be considered slower to access. The process works well when the access patterns are somewhat predictable. However, in the present example the memory access patterns are semi-random because of sampling, and thus generally unpredictable. This means that the L1 cache often contains data that are not necessary, along with the data that are. In some scenarios, it is possible that the majority of cached data is unnecessary for most of the operation time. The L1 cacheline (i.e. the number of bytes the L1 cache fetches) varies from device to device. In one example, the L1 cache fetches 128 bytes of data from device memory each time there is a request that is not found in L1 (i.e. a cache miss). Only a small portion of this data is used (e.g., 8 bytes). As such, in this example, there is a large % of wasteful fetching (120 bytes). If the L1 cache is disabled, then the L2 cache is used, which cannot be disabled. With the L2 cache, the fetching is 32 bytes each time we have a cache miss. Hence, a smaller % of wasteful data is fetched (24 bytes wasted in that case).

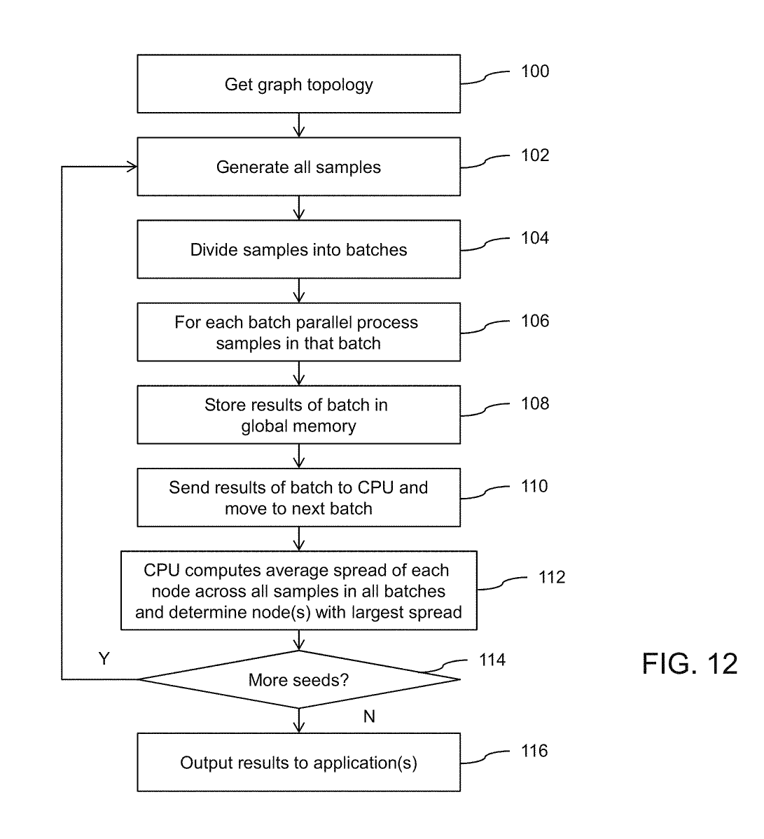

FIG. 12 provides a flow chart illustrating example computer executable instructions that can be implemented in calculating influence spread for a social network platform 12. At step 100 the CPU 16 gets the graph topology to be processed, and generates all samples 50 at step 102, where one sample 50 corresponds to a collection of all edge weights for the graph 14. The set of samples 50 is then divided into batches 64 at step 104, according to the constraints of the multi-processor platform 18 being used. It can be appreciated, however, that for smaller graphs and/or multi-processor platforms 18 with enough threads 66, the set of samples 50 could be processed in a single batch 64.

For each batch 64, the multi-processor platform 18 such as a GPU is used at step 106 to parallel process the samples 50 in that batch 64. The results of that batch 64 are stored in the global memory 24 at step 108. The results correspond to the spread of each graph node per sample 50 in that batch 64. The results are then sent back to the CPU 16 at step 110, and the CPU 16 then moves to the next batch 64 and sends that data to the multi-platform 18 such that steps 106-110 are repeated for all batches 64. The CPU 16 then computes that average spread 65 of each node across all samples 50 in all batches 64 at step 112 in order to determine the node(s) with the largest spread 65.

As indicated above, where the goal is to find a set of seeds, the process described herein can be repeated. In the example shown in FIG. 12, the CPU 16 determines at step 114 whether or not more seeds are to be determined. If so, steps 102-112 are repeated until the required number of seeds is obtained, at which time the results are output at step 116, e.g., to a particular application.

The above-described process was demonstrated using the following setup:

System:
Nvidia GRID K520 on AWS
3074 CUDA Cores
4 GB DDR5 Global Memory
Compute Capability 3.0

Social Graphs:
Twitter_small|236 nodes|2479 edges
Google_medium|638 nodes|16043 edges
Twitter_big|1049 nodes|54555 edges

with a sampling range: 100-10,000 samples.

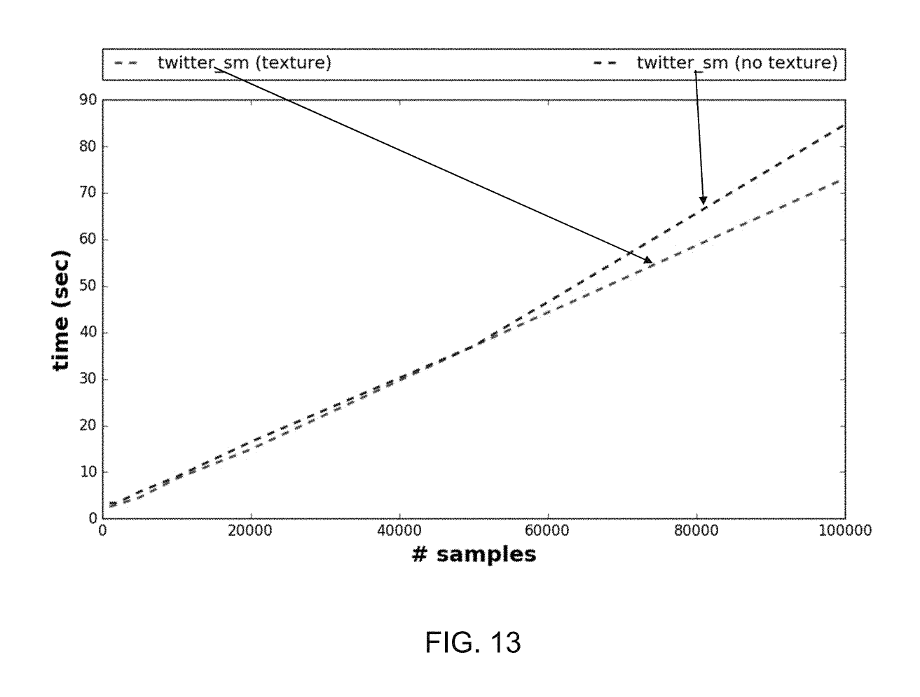

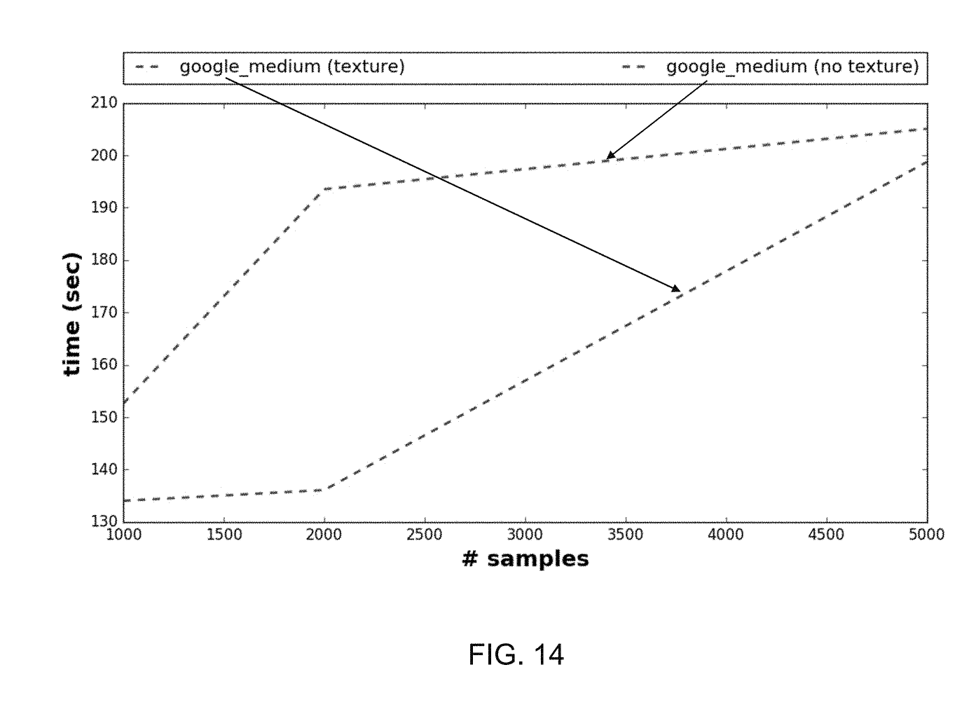

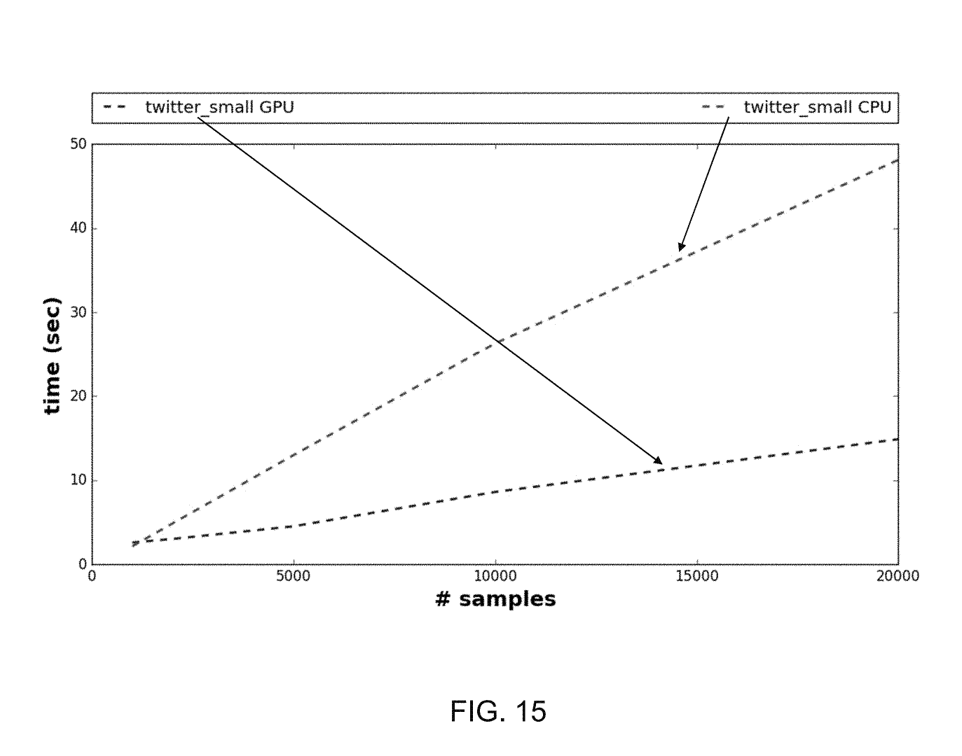

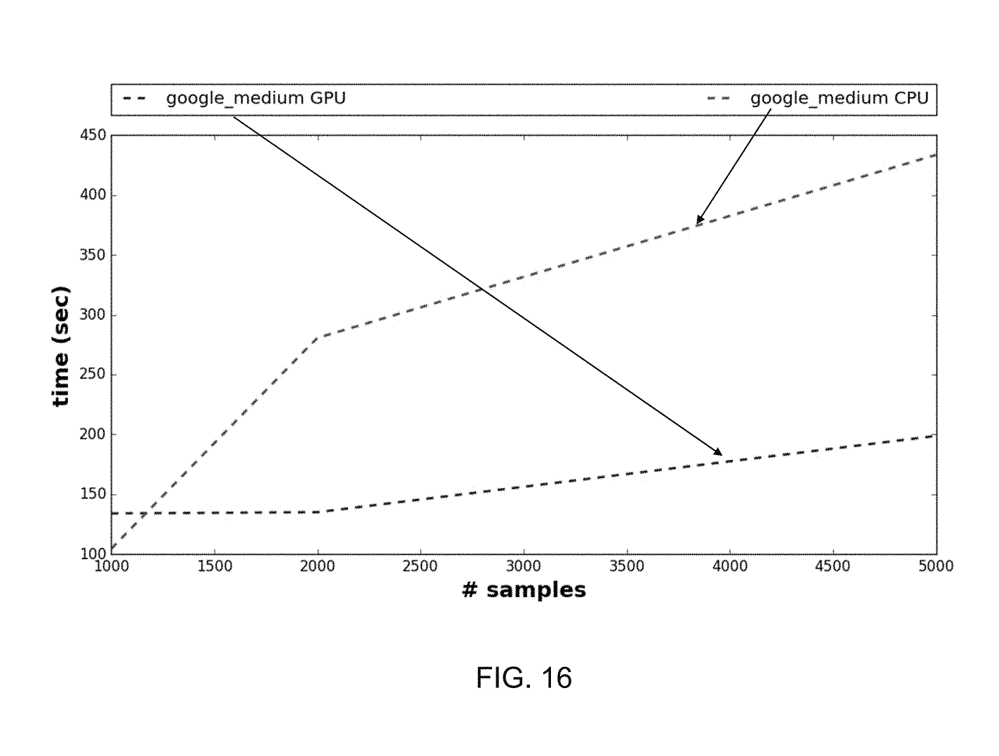

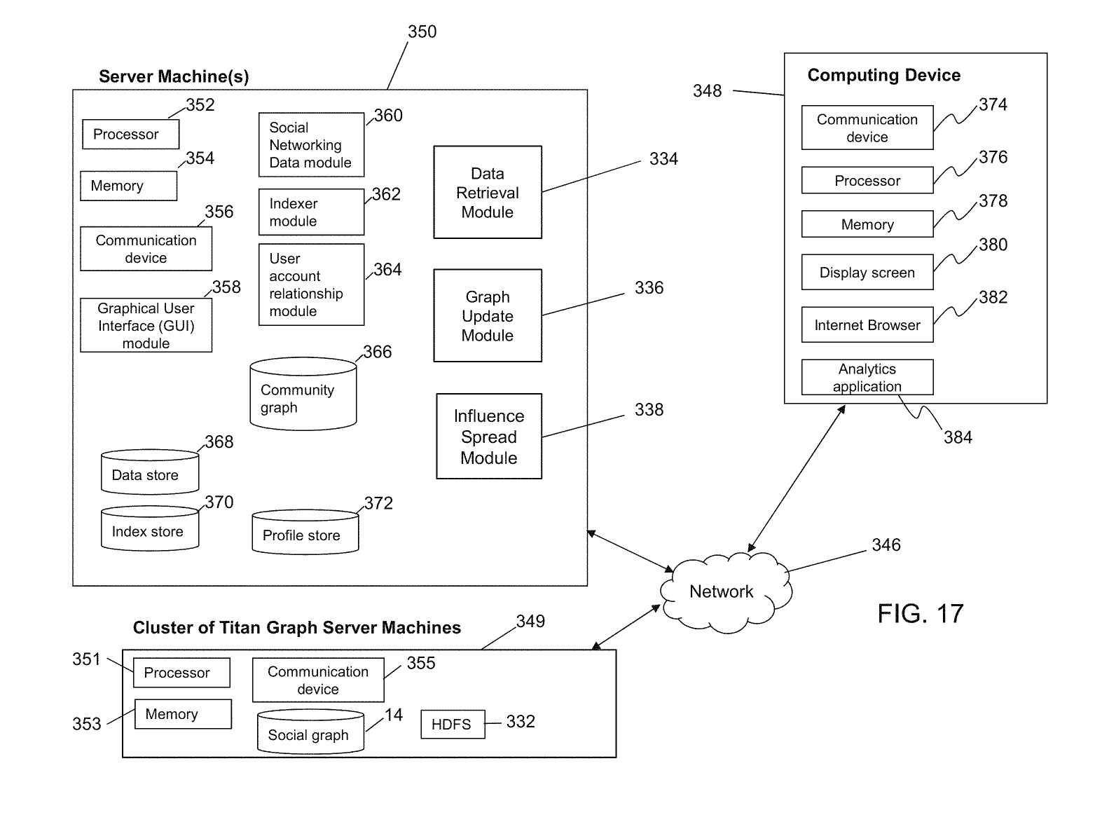

The results shown in FIGS. 13-16 were obtained using the above experimental setup. In FIGS. 13 and 14, the texture memory provides a speed improvement for both a Twitter-based social graph (FIG. 13) and a Google medium-based graph (FIG. 14). In FIGS. 15 and 16, it can be seen that the GPU performs better than a CPU for both a Twitter-based social graph (FIG. 15) and a Google medium-based graph (FIG. 16).

Turning to FIG. 17, a schematic diagram of a computing system is shown within which the influence spread calculations described above can be implemented. It can be appreciated that the server machines 350 shown in FIG. 17 can include processors that operate as the CPU 16 and can include or otherwise have access to a multi-processor platform 18 such as a GPU. The server machine(s) 350, also referred to herein as a server, is in communication with a computing device 348 over a data network 346. The server 350 obtains and analyzes social network data and provides results to the computing device 348 over the network 346. The computing device 348 can receive user inputs through a GUI to control parameters for performing or reviewing an analysis.

It can be appreciated that social network data includes data about the users of the social network platform, as well as the content generated or organized, or both, by the users. Non-limiting examples of social network data includes the user account ID or user name, a description of the user or user account, the messages or other data posted by the user, connections between the user and other users, location information, etc. An example of connections is a “user list”, also herein called “list”, which includes a name of the list, a description of the list, and one or more other users which the given user follows. The user list is, for example, created by the given user.

The server 350 includes a processor 352 (e.g., the CPU 16), and a memory device 354. In an example embodiment, the server 350 includes one or more processors (e.g. a central processor system) and a large amount of memory capacity. In another example embodiment, the memory device 354 or memory devices are solid state drives for increased read/write performance. In another example embodiment, multiple servers are used to implement the methods described herein. In other words, in an example embodiment, the server 350 refers to a server system. In another example embodiment, other currently known computing hardware or future known computing hardware is used, or both.

The server 350 also includes a communication device 356 to communicate via the network 346. The network 346 may be a wired or wireless network, or both. In an example embodiment, the server 350 also includes a GUI module 356 for displaying and receiving data via the computing device 348. The server 350 also includes: a social networking data module 360, an indexer module 362, and a user account relationship module 364. Other components or modules may also be utilized by or included in the server 350 even if not shown in this illustrative example. Similarly, other functionality can be implemented by the modules shown in FIG. 17.

The server 350 also includes a number of databases, including a data store 368, an index store 370, a profile store 372, and a database for storing community graph information 366.

The social networking data module 360 is used to receive a stream of social networking data. In an example embodiment, millions of new messages are delivered to social networking data module 360 each day, and in real-time. The social networking data received by the social networking data module 360 is stored in the data store 368.

In an example embodiment, only certain types of data are received based on the follower and friend API, such as node and edge connection data. In other words, the message content may or may not be received and stored by the server 350.

The indexer module 362 performs an indexer process on the data in the data store 68 and stores the indexed data in the index store 370. In an example embodiment, the indexed data in the index store 370 can be more easily searched, and the identifiers in the index store can be used to retrieve the actual data (e.g. full messages).

A social network graph is also obtained from the social networking platform server, not shown, and is stored in the social network graph database. The social network graph 14, when given a user as an input to a query, can be used to return all users “following” the queried user.

The profile store 372 stores meta data related to user profiles. Examples of profile related meta data include the aggregate number of followers of a given user, self-disclosed personal information of the given user, location information of the given user, etc. The data in the profile store 372 can be queried.

In an example embodiment, the user account relationship module 364 can use the social network graph 14 and the profile store 372 to determine which users are following a particular user. In other words, a user can be identified as “friend” or “follower”, or both, with respect to one or more other users. The module 64 may also configured to determine relationships between user accounts, including reply relationships, mention relationships, and re-post relationships.

The server 350 may also include a community identification module or capability (not shown) that is configured to identify communities (e.g. a cluster of information within a queried topic such as Topic A) within a topic network. The output from a community identification module comprises a visual identification of clusters (e.g. visually coded) defined as communities of the topic network that contain common characteristics and/or are affected (e.g. influenced such as follower-followee relationships), to a higher degree by other entities (e.g. influencers, experts, high-authority users) in the same community than those in another community.

The server 350 in this example also includes a data retrieval module 334 (e.g., REST module), a graph update module 336, and an influence spread module 338.

The server 350 is in communication with a cluster of titan graph server machines 349, which has memory devices 353 that store the social graph 14 and an HDFS 332. Each server machine in the titan graph cluster 349 includes a processor 351 and a communication device 355 for indexing and storing the data. Using the communication devices, the server 350 and the cluster of titan graph server machines 349 communicate with each other over the data network 346. While a cluster of server nodes can be used, it will be appreciated that different numbers of server nodes may be used to form the cluster.

The computing device 348 includes a communication device 374 to communicate with the server 350 via the network 346, a processor 376, a memory device 378, a display screen 380, and an Internet browser 382. In an example embodiment, the GUI provided by the server 350 is displayed by the computing device 348 through the Internet browser 382. In another example embodiment, where an analytics application 384 is available on the computing device 348, the GUI is displayed by the computing device through the analytics application 384. It can be appreciated that the display screen 380 may be part of the computing device 348 (e.g. as with a mobile device, a tablet, a laptop, a wearable computing device, etc.) or may be separate from the computing device (e.g. as with a desktop computer, or the like).

Although not shown, various user input devices (e.g. touch screen, roller ball, optical mouse, buttons, keyboard, microphone, etc.) can be used to facilitate interaction between the user and the computing device 348.

It will be appreciated that, in another example embodiment, the system includes multiple server machines. In another example embodiment, there are multiple computing devices that communicate with the one or more servers.

It will also be appreciated that one or more computer readable mediums may collectively store the computer executable instructions that, when executed, perform the computations described herein.

It will also be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 10, any component of or related to the system 10, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of determining influence spread in social networks, the method comprising:
generating a plurality of samples using a computing device, each sample corresponding to a collection of all edge weights for a social network graph topology;
allocating, by the computing device, the plurality of samples into at least one batch, a size of which is being determined according to a number of threads and global memory space available in a multi-processor platform;
for each batch:
parallel processing the samples in that batch using the multi-processor platform to generate results corresponding to a spread of each graph node per sample in that batch; and
storing results of that batch in the global memory accessible to the multi-processor platform;
computing, using the computing device, an average spread of each node across all samples in all batches; and
determining, from the average spreads, one or more nodes having a largest spread.

2. The method of claim 1, wherein the one or more nodes having a largest spread correspond to a first seed, and wherein the method is repeated until a predetermined number of seeds is obtained.

3. The method of claim 1, further comprising outputting the results to a social media intelligence application.

4. The method of claim 1, wherein the multi-processor platform is a graphics processing unit (GPU).

5. The method of claim 1, wherein the multi-processor platform is a multi-core processor.

6. The method of claim 1, wherein each sample is processed in a thread by applying a Naïve Sampling algorithm.

7. The method of claim 1, wherein each sample is processed in a thread by applying a Cohen's Neighborhood Size Estimation algorithm.

8. The method of claim 1, wherein edge weight orders are stored in the global memory accessible to the multi-processor platform by storing the weights for each edge from all samples together in respective blocks of the memory.

9. The method of claim 1, wherein blocks of the memory accessible to the multi-processor platform are fetched at the same time at each memory call using a texture memory structure.

10. The method of claim 1, wherein an L1 cache for the multi-processor platform is disabled such that an L2 cache is utilized to reduce wasteful data at each memory call.

11. The method of claim 1, wherein the social network graph topology has a distribution associated with each edge.

12. The method of claim 11, wherein the distribution is an exponential distribution with a parameter that varies from edge to edge.

13. The method of claim 1, wherein the parallel processing of each sample considers a deadline time.

14. A computing system for determining influence spread in social networks, the system comprising:
a central processor system, a multi-processor platform, and a global memory;
the central processor system configured to generate a plurality of samples, each sample corresponding to a collection of all edge weights for a social network graph topology;
the central processor system configured to allocate the plurality of samples into at least one batch, a size of which is being determined according to a number of threads and global memory space available in the multi-processor platform;
for each batch:
the multi-processor platform configured to parallel process the samples in that batch to generate results corresponding to a spread of each graph node per sample in that batch; and
the global memory configured to store results of that batch, the global memory accessible to the multi-processor platform;
the central processor system configured to compute an average spread of each node across all samples in all batches; and
the central processor system configured to determine, from the average spreads, one or more nodes having a largest spread.

15. The computing system of claim 14, wherein the multi-processor platform comprises a graphics processing unit (GPU).

16. The computing system of claim 14, wherein the one or more nodes having a largest spread correspond to a first seed, and wherein the system is configured to repeatedly process the samples until a predetermined number of seeds is obtained.

17. The computing system of claim 14 wherein the central processor system is configured to output the results to a social media intelligence application.

18. The computing system of claim 14, wherein the multi-processor platform is a multi-core processor.

19. The computing system of claim 14, wherein each sample is processed in a thread by applying a Naïve Sampling algorithm.

20. The computing system of claim 14, wherein each sample is processed in a thread by applying a Cohen's Neighborhood Size Estimation algorithm.

21. The computing system of claim 14, wherein edge weight orders are stored in the global memory accessible to the multi-processor platform by storing the weights for each edge from all samples together in respective blocks of the global memory.

22. The computing system of claim 14, wherein blocks of the global memory accessible to the multi-processor platform are fetched at the same time at each memory call using a texture memory structure.

23. The computing system of claim 14, wherein an L1 cache for the multi-processor platform is disabled such that an L2 cache is utilized to reduce wasteful data at each memory call.

24. The computing system of claim 14, wherein the social network graph topology has a distribution associated with each edge.

25. The computing system of claim 24, wherein the distribution is an exponential distribution with a parameter that varies from edge to edge.

26. The computing system of claim 14, wherein the parallel processing of each sample considers a deadline time.

27. One or more non-transitory computer readable mediums for determining influence spread in social networks, the one or more non-transitory computer readable mediums collectively comprising computer executable instructions, that when executed, cause a computing system to at least:
generate a plurality of samples, each sample corresponding to a collection of all edge weights for a social network graph topology;
allocate the plurality of samples into at least one batch, a size of which is being determined according to a number of threads and global memory space available in a multi-processor platform;
for each batch:
parallel process the samples in that batch using the multi-processor platform to generate results corresponding to a spread of each graph node per sample in that batch;
store results of that batch in the global memory accessible to the multi-processor platform; and
compute an average spread of each node across all samples in all batches; and
determine, from the average spreads, one or more nodes having a largest spread.
